(19) United States
(12) Patent Application Publication
(10) Pub. No.: US 2023/0153785 A1
(43) Pub. Date: May 18, 2023

(54) METHOD AND DEVICE FOR GENERATING PAYMENT CODE

(71) Applicant: CHINA UNIONPAY CO., LTD., Shanghai (CN)

(72) Inventors: Zhirong SHEN, Shanghai (CN); Jien ZHOU, Shanghai (CN); Jianbin GAO, Shanghai (CN)

(21) Appl. No.: 17/919,850

(22) PCT Filed: Aug. 20, 2021
(86) PCT No.: PCT/CN2021/113772

§ 371 Date: Oct. 19, 2022

(30) Foreign Application Priority Data
Jan. 19, 2021 (CN) 202110069523.1

(51) Int. Cl. G06Q 20/32

(52) U.S. Cl. CPC G06Q 20/3274

(57) ABSTRACT

A payment code generation method and device, for use in solving the problem that additional information prompt cannot be performed due to less information in a payment code. The method comprises: receiving a payment code generation request sent by a terminal, the payment code generation request comprising a payment-related object identifier (301); obtaining payment information of a payment-related object and an affiliated feature identifier of the payment-related object according to the payment-related object identifier (302); determining affiliated information of the payment-related object according to the affiliated feature identifier of the payment-related object (303); and generating a payment code generation response according to the payment information and affiliated information of the payment-related object, and sending the payment code generation response to the terminal, such that the terminal generates a payment code according to the payment code generation response (304).

### CROSS-REFERENCE OF RELATED APPLICATIONS

The present application is a national phase entry under 35 U.S.C. § 371 of International Application No. PCT/CN2021/113772, filed on Aug. 20, 2021, which claims the priority of Chinese Patent Application No. 202110069523.1, filed with the China National Intellectual Property Administration on Jan. 19, 2021 and entitled “Method and Device for Generating Payment Code”, the entire content of which is hereby incorporated by reference.

### FIELD

Embodiments of the application relate to the field of computer technologies, and in particular, to a method and device for generating a payment code.

### BACKGROUND

The payment code is used in a payment method of online payment software. For example, in convenience stores, shops, restaurants and other consumption places, when a user shows a mobile phone when checking out, the merchant can use an infrared barcode scanner to scan the one-dimensional barcode displayed on the user's mobile phone to initiate the checkout. When switching to the QR code, the other party can use a mobile phone or special device to scan and initiate a transaction.

In the existing code scanning process, the displayed code (QR Code) generally only has the necessary payment account information (scanned) or order information (main scan), that is, the payment code only carries the payment information and has a single function. The color or background color of the payment code is fixed, and it is not possible to obtain more information about the merchant or personal account from the payment code.

### BRIEF SUMMARY

Embodiments of the application provide a method and device for generating a payment code, so as to solve the problem that additional information cannot be prompted due to less information in the payment code.

The technical solutions provided in the invention are as follows.

In one aspect, embodiments of the application provide a method for generating a payment code, including:

receiving a payment code generation request sent by a terminal, wherein the payment code generation request contains an identifier of a payment-related object;

obtaining payment information of the payment-related object and an affiliated feature identifier of the payment-related object according to the identifier of the payment-related object;

determining affiliated information of the payment-related object according to the affiliated feature identifier of the payment-related object;

generating a payment code generation response according to the payment information and the affiliated information of the payment-related object, and sending the payment code generation response to the terminal, so that the terminal generates the payment code according to the payment code generation response.

Optionally, the identifier of the payment-related object is a merchant identifier, and the affiliated feature identifier of the payment-related object includes at least a system preset feature identifier;

the obtaining payment information of the payment-related object and an affiliated feature identifier of the payment-related object according to the identifier of the payment-related object, includes:

sending a first payment code information obtaining request to a merchant management server according to the merchant identifier;

receiving a first payment code information obtaining response sent by the merchant management server, wherein the first payment code information obtaining response contains payment information corresponding to the merchant identifier;

determining a corresponding system preset feature identifier according to the merchant identifier.

Optionally, the identifier of the payment-related object is a user identifier, and the affiliated feature identifier of the payment-related object includes a system preset feature identifier and a custom feature identifier;

the obtaining payment information of the payment-related object and an affiliated feature identifier of the payment-related object according to the identifier of the payment-related object, includes:

sending a second payment code information obtaining request to a user management server according to the user identifier;

receiving a second payment code information obtaining response sent by the user management server, wherein the second payment code information obtaining response contains payment information and a custom feature identifier corresponding to the user identifier, and the custom feature identifier corresponding to the user identifier is determined according to a user's operation on a configuration interface of the terminal;

determining a corresponding system preset feature identifier according to the user identifier.

Optionally, the determining affiliated information of the payment-related object according to the affiliated feature identifier of the payment-related object, includes:

receiving affiliated feature information of the payment-related object sent by an information management server corresponding to the payment-related object;

storing the affiliated feature information and converting the affiliated feature information into the affiliated information.

Optionally, before receiving the affiliated feature information of the payment-related object sent by the information management server corresponding to the payment-related object, the method further includes:

generating a feature information obtaining request according to the affiliated feature identifier of the payment-related object;

sending the feature information obtaining request to the information management server;

the receiving affiliated feature information of the payment-related object sent by an information management server corresponding to the payment-related object, includes:

receiving a feature information obtaining response sent by the information management server, wherein the feature information obtaining response includes the affiliated feature information of the payment-related object.

Optionally, the converting the affiliated feature information into the affiliated information, includes:

determining a corresponding information affiliation rule according to the affiliated feature identifier of the payment-related object;

comparing the affiliated feature information with the information affiliation rule to obtain the affiliated information.

In another aspect, embodiments of the application provide a method for generating a payment code, including:

generating a payment code generation request in response to a payment code generation operation triggered on a payment interface, wherein the payment code generation request contains an identifier of a payment-related object;

sending the payment code generation request to a payment code server, so that the payment code server determines payment information and affiliated information of the payment-related object according to the payment code generation request;

receiving a payment code generation response sent by the payment code server, wherein the payment code generation response contains the payment information and affiliated information of the payment-related object;

generating and displaying the payment code according to the payment information and the affiliated information.

Optionally, the identifier of the payment-related object is a user identifier; and the affiliated information is determined by the payment code server according to a system preset feature identifier and a custom feature identifier;

the method further includes:

displaying a configuration interface corresponding to the user identifier;

obtaining the custom feature identifier corresponding to the user identifier in response to a user operation triggered on the configuration interface;

sending the custom feature identifier corresponding to the user identifier to a user management server.

Optionally, the generating the payment code according to the payment information and the affiliated information, includes:

determining target affiliated information according to a priority corresponding to the affiliated information;

determining a target generated code style corresponding to the target affiliated information according to a correspondence between affiliated information and payment code style;

generating the payment code according to the payment information, and displaying the payment code according to the target generated code style.

In another aspect, embodiments of the application provide a device for generating a payment code, including:

a first transceiver unit, configured to receive a payment code generation request sent by a terminal, wherein the payment code generation request contains an identifier of a payment-related object;

an obtaining unit, configured to obtain payment information of the payment-related object and an affiliated feature identifier of the payment-related object according to the identifier of the payment-related object;

a determining unit, configured to determine affiliated information of the payment-related object according to the affiliated feature identifier of the payment-related object;

a generating unit, configured to generate a payment code generation response according to the payment information and the affiliated information of the payment-related object;

the first transceiver unit being further configured to send the payment code generation response to the terminal, so that the terminal generates a payment code according to the payment code generation response.

Optionally, the identifier of the payment-related object is a merchant identifier, and the affiliated feature identifier of the payment-related object includes at least a system preset feature identifier;

the obtaining unit is configured to:

send a first payment code information obtaining request to a merchant management server according to the merchant identifier;

receive a first payment code information obtaining response sent by the merchant management server, wherein the first payment code information obtaining response contains payment information of the merchant identifier;

determine a corresponding system preset feature identifier according to the merchant identifier.

Optionally, the identifier of the payment-related object is a user identifier, and the affiliated feature identifier of the payment-related object includes a system preset feature identifier and a custom feature identifier;

the obtaining unit is configured to:

send a second payment code information obtaining request to a user management server according to the user identifier;

receive a second payment code information obtaining response sent by the user management server, wherein the second payment code information obtaining response contains payment information of the user identifier and a custom feature identifier corresponding to the user identifier, and the custom feature identifier corresponding to the user identifier is determined according to a user's operation on a configuration interface of the terminal;

determine a corresponding system preset feature identifier according to the user identifier.

Optionally, the determining unit is configured to:

receive affiliated feature information of the payment-related object sent by an information management server corresponding to the payment-related object;

store the affiliated feature information and convert the affiliated feature information into the affiliated information.

Optionally, the determining unit is configured to:

generate a feature information obtaining request according to the affiliated feature identifier of the payment-related object;

send the feature information obtaining request to the information management server;

receive a feature information obtaining response sent by the information management server, wherein the feature information obtaining response includes the affiliated feature information of the payment-related object.

Optionally, the determining unit is configured to:

determine a corresponding information affiliation rule according to the affiliated feature identifier of the payment-related object;

compare the affiliated feature information with the information affiliation rule to obtain the affiliated information.

In another aspect, embodiments of the application provide a device for generating a payment code, including:

a response unit, configured to generate a payment code generation request in response to a payment code generation operation triggered on a payment interface, wherein the payment code generation request contains an identifier of a payment-related object;

a second transceiver unit, configured to send the payment code generation request to a payment code server, so that the payment code server determines payment information and affiliated information of the payment-related object according to the payment code generation request;

the second transceiver unit being further configured to receive a payment code generation response sent by the payment code server, wherein the payment code generation response contains the payment information and affiliated information of the payment-related object;

a generating unit, configured to generate and display the payment code according to the payment information and the affiliated information.

Optionally, the identifier of the payment-related object is a user identifier; and the affiliated information is determined by the payment code server according to a system preset feature identifier and a custom feature identifier;

the response unit is configured to display a configuration interface corresponding to the user identifier; and obtain the custom feature identifier corresponding to the user identifier in response to a user operation triggered on the configuration interface;

the second transceiver unit is further configured to send the custom feature identifier corresponding to the user identifier to a user management server, so that the payment code server obtains the custom feature identifier from the user management server.

Optionally, the generating unit is configured to:

determine target affiliated information according to a priority corresponding to the affiliated information;

determine a target generated code style corresponding to the target affiliated information according to a correspondence between affiliated information and payment code style;

generate the payment code according to the payment information, and display the payment code according to the target generated code style.

In another aspect, embodiments of the application provide an electronic device, including:

a memory, configured to store executable instructions;

a processor, configured to read and execute the executable instructions stored in the memory to implement the method described in any one of the above embodiments.

In another aspect, embodiments of the application provide a computer readable storage medium, where instructions in the computer readable storage medium, when executed by a processor, enable the processor to perform the method described in any one of the above embodiments.

In another aspect, embodiments of the invention provide a computer program product, including a computer program stored on a computer readable storage medium, where the computer program includes program instructions which, when executed by a computer, cause the computer to perform steps of the method described in any one of the above embodiments.

In the embodiments of the application, after receiving the user operation, the terminal sends a payment code generation request to the server. The payment code generation request contains the identifier of the payment-related object. The payment-related object may be a user or a merchant. After receiving the payment code generation request, the server obtains the payment information of the payment-related object and the affiliated feature identifier of the payment-related object according to the identifier of the payment-related object, and determines the affiliated information of the payment-related object according to the affiliated feature identifier of the payment-related object. The server generates a payment code generation response according to the payment information and the affiliated information of the payment-related object, and sends the payment code generation response to the terminal, so that the terminal can generate a payment code according to the payment information and the affiliated information in the payment code generation response. In the embodiments of the application, in addition to displaying the basic payment information through the payment code, the payment code can also be used to prompt the affiliated information of the payment-related object, such as merchant risk information, merchant complaint information, user credit information, user account funds, etc., so as to facilitate the merchant or user to obtain more valuable information from the payment code, increase the use flexibility of the payment code, and improve the user experience.

### BRIEF DESCRIPTION OF THE DRAWINGS

FIG. 1 is a schematic diagram of an application architecture of a method for generating a payment code in an embodiment of the invention;

FIG. 2 is a schematic diagram of another application architecture of a method for generating a payment code in an embodiment of the invention;

FIG. 3 is a schematic flowchart of generating the payment code on the server side in an embodiment of the invention;

FIG. 4 is a schematic diagram of a display style of a payment code in an embodiment of the invention;

FIG. 5 is a schematic flowchart of generating the payment code on the terminal side in an embodiment of the invention;

FIG. 6 is a schematic diagram of a system architecture in an embodiment of the invention;

FIG. 7 is a schematic diagram of a logical architecture of a server in an embodiment of the invention;

FIG. 8 is a schematic diagram of a logical architecture of a terminal in an embodiment of the invention;

FIG. 9 is a schematic diagram of a physical architecture of a computer device in an embodiment of the invention.

### DETAILED DESCRIPTION OF THE EMBODIMENTS

In order to make the objects, technical solutions and advantages of the invention clearer, the invention will be further illustrated below in details with reference to the accompanying drawings. Obviously the described embodiments are a part of the embodiments of the invention but not all the embodiments. Based upon the embodiments of the disclosure, all of other embodiments obtained by those ordinary skilled in the art without creative work pertain to the protection scope of the invention.

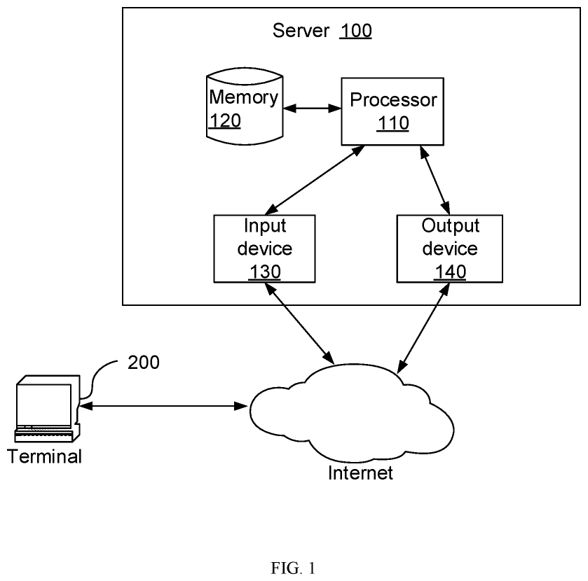

In an implementation, the process of generating a payment code through the terminal can be applied to various application scenarios. Referring to FIG. 1, it is a schematic diagram of an application architecture of a method for generating a payment code in an embodiment of the invention, including a server 100 and a terminal 200.

The terminal 200 may be a mobile or immobile electronic device. For example, mobile phone, tablet computer, notebook computer, desktop computer, various wearable devices, smart TV, in-vehicle devices, or other electronic devices that can implement the above functions. The terminal 200 is provided with a code generator, which can generate a payment code according to the payment information. The terminal 200 may display an interface to a user through a display screen, and receive the user's operation on the interface. The terminal 200 generates a request message based on the user's operation, sends the request message to the server 100, and displays the result to the user through the display screen after receiving the feedback from the server 100.

The terminal 200 and the server 100 may be connected through the Internet to realize mutual communication. Optionally, the Internet uses the standard communication technologies and/or protocols. The Internet is usually internet, but may be any network, including but not limited to any combination of Local Area Network (LAN), Metropolitan Area Network (MAN), Wide Area Network (WAN), mobile, wired or wireless network, private network, or virtual private network. In some embodiments, the data exchanged over network is represented by technologies and/or formats including Hyper Text Mark-up Language (HTML), Extensible Markup Language (XML), etc. Moreover, the conventional encryption technologies, such as Secure Socket Layer (SSL), Transport Layer Security (TLS), Virtual Private Network (VPN), Internet Protocol Security (IPsec), etc., may also be used to encrypt all or some of links. In some other embodiments, the custom and/or dedicated data communication technologies may also be used in place of or in addition to the data communication technologies described above.

The server 100 may provide various network services for the terminal 200. The server 100 may use the cloud computing technology to process information. The server 100 may be an independent physical server, or may be a server cluster or a distributed system composed of multiple physical servers, or may be a cloud server that provides cloud services, cloud databases, cloud computations, cloud functions, cloud storage, network services, cloud communications, middleware services, domain name services, security services, CDN, big data and artificial intelligence platform, and other basic cloud computing services. The terminal may be a smart phone, a tablet computer, a notebook computer, a desktop computer, a smart speaker, a smart watch, etc., but is not limited thereto. The terminal and the server may be connected directly or indirectly through wired or wireless communication, which is not limited in the invention.

For example, the server 100 may include a processor 110 (Center Processing Unit, CPU), a memory 120, an input device 130 and an output device 140, etc. The input device 130 may include a keyboard, a mouse, a touch screen, etc. The output device 140 may include a display device, such as Liquid Crystal Display (LCD), Cathode Ray Tube (CRT), etc.

The memory 120 may include a Read-Only Memory (ROM) and a Random Access Memory (RAM), and provide the program instructions and data stored in the memory 120 to the processor 110. In embodiments of the invention, the memory 120 may be used to store the program of the method for generating a payment code in the embodiments of the invention. In addition, the memory 120 in the embodiments of the invention may also be used to store all information of related accounts.

The processor 110 invokes the program instructions stored in the memory 120, and the processor 110 is configured to execute the steps of any method for generating a payment code in the embodiments of the invention according to the obtained program instructions.

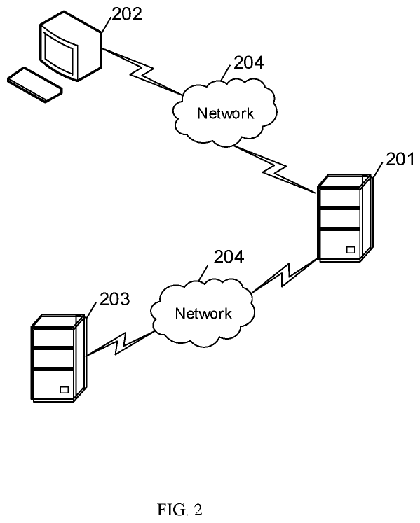

In another application scenario of the embodiments of the present application, referring to FIG. 2, which is a schematic diagram of another application architecture of a method for generating a payment code in embodiments of the present application. A system architecture for generating the payment code includes a payment code server 201, a terminal 202, and an information management server 203. The terminal 202 can establish a connection with the payment code server 201 through a network 204 (such as a wired network or a wireless network), and the payment code server 201 can establish a connection with the information management server 203 through the network 204 (such as a wired network or a wireless network). The information management server 203 here may be an information management server in an external risk control system such as a risk control system, a credit reporting system, an account management system, etc. The affiliated feature information related to users or merchants is stored in the information management server 203. The affiliated feature information includes personal credit reporting information, merchant credit and evaluation information, personnel economic investigation information, account balance information, etc. The payment code server 201 may obtain the above-mentioned affiliated feature information by sending a feature information obtaining request to the information management server 203, or the information management server 203 may push the affiliated feature information actively to the payment code server 201.

Some scenarios to which the embodiments of the invention are applicable are described below in combination with the foregoing system architecture.

Personal consumption scenario: a user clicks “payment code” on the APP of the terminal. The terminal generates a payment code generation request and sends the payment code generation request to the server. The terminal generates a payment code according to the payment information and determines the style of the payment code according to the affiliated information after receiving a payment code generation response. The payment code is displayed on the terminal according to the style. After seeing the code in the style, the user can know whether the accumulated consumption of the account is excessive, whether the credit card has been repaid on time, and other information. When scanning the “payment order code” of a merchant, the user can see whether the merchant has negative comments.

Person-to-person transfer scenario: when checking the “receipt code” of the transfer-in party, the transfer-out party can see whether the transfer-in party has been registered as a specific person by the credit reporting system from the style of the code to avoid the financial risk.

Epidemic prevention scenario: when a user is asked to show the health code, the payment code can be displayed on the terminal. Since the display style of the payment code can be determined by the affiliated information, it can be determined whether the epidemic prevention standard is met according to the display style of green, yellow and red same as the health code. Thus the effect of one code with multiple uses is achieved.

Economic investigation scenario: after a user presents the “payment code”, both the cashier and the cashier system can quickly identify and report according to the display of the payment code. In order to achieve the concealment effect, the display style of the payment code in this scenario can also be set to normal, but the cashier system can read the concealed information from the result of scanning the payment code and prompt the concealed information to the cashier.

Furthermore, the application architecture diagrams in the embodiments of the invention are for the purpose of illustrating the technical solutions in the embodiments of the invention more clearly, and do not constitute a limitation on the technical solutions provided by the embodiments of the invention. Further, the invention is not limited to the above-mentioned business application scenarios, and for other application architectures and business application scenarios, the technical solutions provided by the embodiments of the invention are also applicable to similar problems.

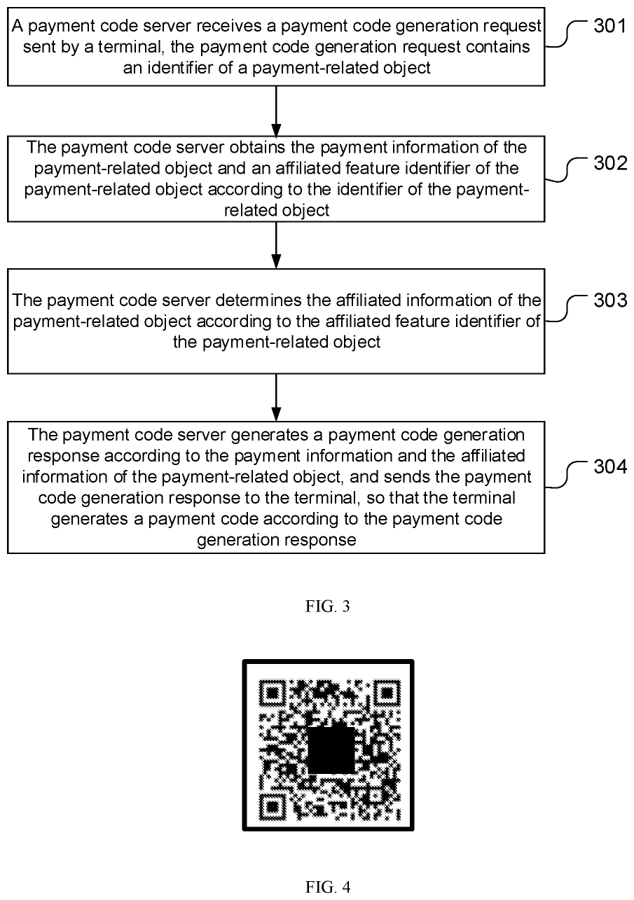

Based on the above design concept, referring to FIG. 3, a detailed process of generating the payment code on the server side in embodiments of the invention is as follows.

Step 301: a payment code server receives a payment code generation request sent by a terminal. The payment code generation request contains an identifier of a payment-related object.

Step 302: the payment code server obtains the payment information of the payment-related object and an affiliated feature identifier of the payment-related object according to the identifier of the payment-related object.

Step 303: the payment code server determines the affiliated information of the payment-related object according to the affiliated feature identifier of the payment-related object.

Step 304: the payment code server generates a payment code generation response according to the payment information and the affiliated information of the payment-related object, and sends the payment code generation response to the terminal, so that the terminal generates a payment code according to the payment code generation response.

In the embodiments of the invention, after receiving the user's operation, the terminal sends a payment code generation request to the payment code server. The payment code generation request contains the identifier of the payment-related object. The payment-related object may be a user or a merchant. After receiving the payment code generation request, the payment code server obtains the payment information of the payment-related object and the affiliated feature identifier of the payment-related object according to the identifier of the payment-related object, and determines the affiliated information of the payment-related object according to the affiliated feature identifier of the payment-related object. The payment code server generates a payment code generation response according to the payment information and the affiliated information of the payment-related object, and sends the payment code generation response to the terminal, so that the terminal can generate a payment code according to the payment information and the affiliated information in the payment code generation response. In the embodiments of the invention, in addition to displaying the basic payment information through the payment code, the payment code can also be used to prompt the affiliated information of the payment-related object, such as merchant risk information, merchant complaint information, user credit information, user account funds, etc., so as to facilitate the merchant or user to obtain more valuable information from the payment code, increase the use flexibility of the payment code, and improve the user experience.

The payment code in the embodiments of the invention may be applied to different modes, including the main scan mode and the scanned mode. Here, in the main scan mode, the merchant presents a payment code to the user, and the color and shape of the payment code displayed by the merchant can prompt the user whether the merchant is a risky merchant or a merchant with a high complaint rate. In the scanned mode, the user shows a payment code to the merchant, and the user can use the payment code display method of different colors and shapes to represent the account balance status, credit card repayment information, whether the monthly accumulated consumption is excessive, and other information. In case of a risk account or a specific account, the system-defined reserved color takes precedence over the user-defined setting.

The two code scanning modes are respectively introduced below.

In the main scan mode, the identifier of the payment-related object is a merchant identifier, and the affiliated feature identifier of the payment-related object includes a system preset feature identifier.

Then, the above-mentioned step in which the payment code server obtains the payment information of the payment-related object and the affiliated feature identifier of the payment-related object according to the identifier of the payment-related object, includes:

sending a first payment code information obtaining request to a merchant management server according to the merchant identifier;

receiving a first payment code information obtaining response sent by the merchant management server, wherein the first payment code information obtaining response contains payment information of the merchant identifier;

determining a corresponding system preset feature identifier according to the merchant identifier.

In an implementation process, after receiving the payment code generation request sent by the terminal, the server determines that the payment code is in the main scan mode according to the merchant identifier in the payment code generation request, and then needs to obtain the payment information of the merchant from the merchant management server corresponding to the merchant. Since the payment information of the merchant is uniformly stored and managed by the merchant management server, the payment code server can send a first payment code information obtaining request to the merchant management server, and the merchant management server finds out the corresponding payment information according to the merchant identifier and generates a first payment code information obtaining response. After receiving the first payment code information obtaining response sent by the merchant management server, the payment code server may obtain the payment information corresponding to the merchant from the first payment code information obtaining response.

Further, since the affiliated features of merchants are generally defined uniformly by the system, the payment code server may obtain the corresponding system preset feature identifier directly according to the merchant identifier.

For example, the payment code server sends a first payment code information obtaining request to the merchant management server, where the first payment code information obtaining request includes the merchant ID, so as to obtain the account information of the merchant ID. The merchant management server returns a default or designated account of the merchant ID through the first payment code information obtaining response. The payment code server sends the account to the terminal after obtaining the account. Then the terminal may generate a payment code according to the account. Further, the payment code server determines the corresponding system preset feature identifier (that is, payment code generation parameters of the merchant) according to the merchant ID. The payment code generation parameters are uniformly defined by the system. The payment code server collects the affiliated information from the external system according to the payment code generation parameters.

In the scanned mode, the identifier of the payment-related object is a user identifier, and the affiliated feature identifier of the payment-related object includes a system preset feature identifier and a custom feature identifier.

Then, the above-mentioned step in which the payment code server obtains the payment information of the payment-related object and the affiliated feature identifier of the payment-related object according to the identifier of the payment-related object, includes:

sending a second payment code information obtaining request to a user management server according to the user identifier;

receiving a second payment code information obtaining response sent by the user management server, wherein the second payment code information obtaining response contains payment information and a custom feature identifier corresponding to the user identifier, and the custom feature identifier corresponding to the user identifier is determined according to a user's operation on a configuration interface of the terminal;

determining a corresponding system preset feature identifier according to the user identifier.

In an implementation process, after receiving the payment code generation request sent by the terminal, the server determines that the payment code is in the scanned mode according to the user identifier, and then needs to obtain the payment information of the user from the user management server corresponding to the user. Since the payment information of the user is uniformly stored and managed by the user management server, the payment code server can send a second payment code information obtaining request to the user management server. The user management server finds out the corresponding payment information according to the user identifier and generates a second payment code information obtaining response. After receiving the second payment code information obtaining response sent by the user management server, the payment code server may obtain the payment information corresponding to the user from the second payment code information obtaining response.

Further, unlike the affiliated features of merchants which are defined uniformly by the system, the affiliated features of the user may also be customized by the user, so the payment code server can not only obtain the corresponding system preset feature identifier directly according to the user identifier, but also obtain the user's custom feature identifier through the second payment code information obtaining request.

For example, the payment code server sends a second payment code information obtaining request to the user management server, where the second payment code information obtaining request includes the user ID, so as to obtain the account information of the user ID. The user management server returns a default or designated card number of the user ID through the second payment code information obtaining response. The payment code server sends the card number to the terminal after obtaining the card number. Then the terminal may generate a payment code according to the card number. Further, the second payment code information obtaining response also includes a custom feature identifier. The custom feature identifier corresponding to the user ID is determined according to the user operation of the user on the configuration interface of the terminal. That is, the user performs an operation on the configuration interface of the terminal in advance, and the terminal determines the custom feature of the user according to the operation and sends the custom feature identifier to the user management server. In this way, when receiving the second payment code information obtaining request, the user management server can add the custom feature identifier of the user to the second payment code information obtaining response to be sent to the payment code server together. Therefore, by sending the second payment code information obtaining request, the payment code server can obtain both the payment information and the custom feature identifier.

Moreover, the affiliated feature identifier of the user also includes a system preset feature identifier. The payment code server determines the corresponding system preset feature identifier (that is, payment code generation parameters of the user) according to the user ID. The payment code generation parameters are uniformly defined by the system. The payment code server collects the affiliated information of the user from the external system according to the payment code generation parameters.

For example, in a payment APP, the user generally binds a plurality of card numbers or payment accounts, so the setting of the payment code can also direct at all accounts of the user or a single account of the user. Table 1 shows the settings of affiliated features for all accounts of the user. One prompt item corresponds to one affiliated feature. The features with remark “Defined uniformly by system” are system preset features, and the features with remark “Defined by user” are user custom features.

TABLE 1

| | | | Generated | |
|---|---|---|---|---|
| Priority | Prompt item | Judgment condition | code style | Remark |
| −1 | Risky merchant? | Risk control system | Style1 | Defined |
| | | returns yes or no | | uniformly by |
| | | | | system |
| −2 | Merchant with | Merchant system | Style2 | Defined |
| | negative comment? | returns yes or no | | uniformly by |
| | Specific person? | Credit reporting system | | system |
| | | returns yes or no | | |
| −3 | Risky person? | XX system returns yes | Style3 | Defined |
| | | or no | | uniformly by |
| | | | | system |
| −4 | Person in high-risk | Health code system | Style4 | Defined |
| | epidemic area? | returns yes or no | | uniformly by |
| | | | | system |
| 1 | Natural monthly | Monthly cumulative | Style11 | Defined by |
| | cumulative | consumption of all | | user, |
| | consumption is | bound accounts of | | Orange code |
| | excessive | user > Set amount | | |

Table 2 shows the settings of affiliated features for a single account of the user. The features with remark “Defined uniformly by system” are system preset features, and the features with remark “Defined by user” are user custom features.

TABLE 2

| | | | Generated | |
|---|---|---|---|---|
| Priority | Prompt item | Judgment condition | code style | Remark |
| −1 | Risky account? | Risk control system | Style5 | Defined |
| | | returns yes or no | | uniformly by |
| | | | | system |
| 1 | Whether current bill | Issuing bank returns | Style12 | Defined by |
| | of credit card has been | yes or no | | user, |
| | repaid? | | | Blue code |
| 2 | Whether balance of | Account balance < Set | Style12 | Defined by |
| | pre-stored account is | amount | | user, |
| | insufficient? | | | Yellow code |

The payment code settings for all accounts have higher priority than the payment code settings for a single account. The priority of system preset features defined uniformly by the system is higher than that of user custom features. The system assigns different feature prompt item numbers to prompt items, and the numbers are globally unique.

Moreover, one payment code display style is set corresponding to each prompt item in the tables, and the attributes thereof may include color, shape, center picture, border, background color, etc. of the code, and the attributes can be extended. A payment code display style is as shown in FIG. 4.

The payment code display style uniformly defined by the system cannot be changed by the user, and the user-defined payment code display style can be set by the user. In order to facilitate the user to identify, the central picture of the payment code in FIG. 4 can be defined as various common warning pictures, similar to the warning pictures on the dashboard of a car. The shape of the code may be square, round, etc., and the border may define whether to display and the displayed color. The display style of the payment code supports user personalization, thereby improving the user experience.

The affiliated feature information in the embodiments of the invention may be collected in advance and then stored in the payment code server, or may be collected in real time after the payment code server receives a request sent by the terminal. Preferably, in order to reduce the consumed time of the payment code generation process, the payment code server stores the collected information in a cache such as Redis in the form of Key-Value.

Further, the manner for the payment code server to obtain the affiliated information in the embodiments of the invention may include active pulling and passive pushing, and both pulling and pushing include batch and real-time manners.

Here, under passive pushing, the step in which the payment code server determines the affiliated information of the payment-related object according to the affiliated feature identifier of the payment-related object includes:

receiving affiliated feature information of the payment-related object sent by an information management server corresponding to the payment-related object;

storing the affiliated feature information and converting the affiliated feature information into the affiliated information.

In an implementation process, the prompt items with infrequent information update and high-risk nature, such as personal credit information, merchant credit and evaluation, etc., may be obtained by means of batch push from the external system, and may be HTTP messages that take effect immediately or may be in the form of files that are loaded and take effect regularly. The information with high timeliness requirement, such as merchant risk, transfer risk of illegal fund in account, etc., may be pushed by the external risk control system in real time, and received by the payment code server immediately and take effect.

In the active pulling mode, before the payment code server receives the affiliated feature information of the payment-related object sent by the information management server corresponding to the payment-related object, the method further includes:

generating a feature information obtaining request according to the affiliated feature identifier of the payment-related object;

sending the feature information obtaining request to the information management server.

The step in which the payment code server receives the affiliated feature information of the payment-related object sent by the information management server corresponding to the payment-related object, includes:

receiving a feature information obtaining response sent by the information management server, wherein the feature information obtaining response includes the affiliated feature information of the payment-related object.

In an implementation process, for the information such as whether the bill of the credit card has been repaid, the payment code server may periodically query and pull information in batches from a bank or an institution according to the billing period of the credit card. For the information such as the user's account balance is insufficient, the payment code server may query the bank or institution to obtain the real-time balance information when a code is generated.

Moreover, the payment code server can also perform local statistics, that is, the payment code server can perform local statistics and store the information such as accumulative reminder of consumption amount in the cycle.

Further, the payment code server needs to process the collected original information and convert it into a data form that can be directly read. Then, the step of converting the affiliated feature information into the affiliated information, includes:

determining a corresponding information affiliation rule according to the affiliated feature identifier of the payment-related object;

comparing the affiliated feature information with the information affiliation rule to obtain the affiliated information.

In an implementation process, the payment code server may obtain the affiliated feature information from an external network system server in advance, and cache the affiliated feature information. After receiving a payment code generation request sent by the terminal, the payment code server queries the affiliated feature information in the cache according to the user ID in the request and the affiliated feature identifier, and determines the corresponding information affiliation rule, such as the configuration information of the items of the payment code shown in Table 1 or Table 2. According to the configuration information, the affiliated feature information is calculated and processed according to the judgment conditions, to obtain a calculation result of yes or no. After all the prompt items are calculated, they are assembled into an overall structure as the affiliated information.

After that, the payment code server assembles the payment information and the affiliated information into a response message and sends it back to the terminal according to the user settings. The payment code server fills the display requirements according to the user settings, fills the number of each prompt item and the corresponding payment code style in the response message, and returns the response message to the terminal after supplementing the basic information of the payment code generation.

The display requirements filled in the response message are divided into the following cases: (1) present the payment code in only one style, that is, display the payment code according to the prompt item with the highest priority; (2) scroll to present the payment code according to all the prompt items that meet the conditions in the order of priorities from high to low.

Based on the operation process of the terminal described above, as shown in FIG. 5, correspondingly the detailed process of generating the payment code on the terminal side in embodiments of the invention is as follows.

Step 501: a terminal generates a payment code generation request in response to a payment code generation operation triggered on a payment interface. The payment code generation request contains an identifier of a payment-related object.

Step 502: the terminal sends the payment code generation request to a payment code server, so that the payment code server determines the payment information and affiliated information of the payment-related object according to the payment code generation request.

Step 503: the terminal receives a payment code generation response sent by the payment code server. The payment code generation response contains the payment information and affiliated information of the payment-related object.

Step 504: the terminal generates and displays a payment code according to the payment information and the affiliated information.

In an implementation process, after receiving the user operation, the terminal sends a payment code generation request to the server. The payment code generation request contains the identifier of the payment-related object. The payment-related object may be a user or a merchant. After receiving the payment code generation request, the server obtains the payment information of the payment-related object and the affiliated feature identifier of the payment-related object according to the identifier of the payment-related object, and determines the affiliated information of the payment-related object according to the affiliated feature identifier of the payment-related object. The server generates a payment code generation response according to the payment information and the affiliated information of the payment-related object, and sends the payment code generation response to the terminal, so that the terminal can generate a payment code according to the payment information and the affiliated information in the payment code generation response. In the embodiments of the invention, in addition to displaying the basic payment information through the payment code, the payment code can also be used to prompt the affiliated information of the payment-related object, such as merchant risk information, merchant complaint information, user credit information, user account funds, etc., so as to facilitate the merchant or user to obtain more valuable information from the payment code, increase the use flexibility of the payment code, and improve the user experience.

Further, the identifier of the payment-related object is a user identifier; and the affiliated information is determined by the payment code server according to a system preset feature identifier and a custom feature identifier.

Before the terminal generates the payment code generation request in response to the payment code generation operation triggered on the payment interface, where the payment code generation request contains the identifier of the payment-related object, the method further includes:

the terminal displays a configuration interface corresponding to the user identifier;

the terminal obtains a custom feature identifier corresponding to the user identifier in response to a user operation triggered on the configuration interface;

the terminal sends the custom feature identifier corresponding to the user identifier to a user management server, so that the payment code server obtains the custom feature identifier from the user management server.

In an implementation process, for the affiliated features of the user, not only the system preset features are directly determined by the system, but also the custom features corresponding to a user subset can be preset by the user. The custom feature identifier corresponding to the user identifier is determined according to the user operation of the user on the configuration interface of the terminal. That is, the user performs an operation on the configuration interface of the terminal in advance, and the terminal determines the custom feature of the user according to the user operation and sends the custom feature identifier to the user management server. In this way, when receiving the second payment code information obtaining request, the user management server can add the custom feature identifier of the user to the second payment code information obtaining response to be sent to the payment code server together. Therefore, by sending the second payment code information obtaining request, the payment code server can obtain both the payment information and the custom feature identifier.

Therefore, the payment code server can not only obtain the corresponding system preset feature identifier directly according to the user identifier, but also obtain the user's custom feature identifier through the second payment code information obtaining request.

Further, the step of generating the payment code according to the payment information and the affiliated information, includes:

determining target affiliated information according to a priority corresponding to the affiliated information;

determining a target generated code style corresponding to the target affiliated information according to a correspondence between affiliated information and payment code style;

generating a payment code according to the payment information, and displaying the payment code according to the target generated code style.

In an implementation process, a code generator is provided in the terminal, and the code generator generates a payment code in the target generated code style from the information in the received response message according to the definition of the interface specification. The payment code server provides the SDK development kit to the code generator, facilitating the rapid integration of different types of terminals.

Here, the code generation interface specification has many kinds of definitions, including: fixed field format, TLV format, etc. The embodiments of the invention are illustrated by the TLV format shown in Table 3.

TABLE 3

| Tag | Name | Length | Value | | Remark |
|---|---|---|---|---|---|
| Tag1 | Version number | 2 | 01 | | |
| Tag2 | Main account | 19 | | | |
| . . . | The above is | | | | |
| | general | | | | |
| | interface | | | | |
| | content | | | | |
| Tag12 | Payment code | 2 | 01: Present highest priority | | Must |
| | presentation | | 02: Scroll to present all | | |
| | requirement | | | | |
| Tag13 | Merchant risk | 64 | Data Name | Format | Optional |
| | | | Priority | ans 2 | Only prompt items |
| | | | Generated | ans 5 | that meet |
| | | | code style | | conditions will |
| | | | Prompt message | ans 32 | appear in |
| | | | | | message. Arrange |
| | | | | | by priority from |
| | | | | | high to low. |

| | | | |
|---|---|---|---|
| Tag14 | Merchant credit | 64 | Same format as above |
| Tag15 | User credit | 64 | Same format as above |
| Tag16 | Cumulative | 64 | Same format as above |
| | consumption is | | |
| | excessive | | |
| Tag17 | Insufficient | 64 | Same format as above |
| | funds in | | |
| | account | | |
| Tag18 | Credit card | 64 | Same format as above |
| | is unpaid | | |
| Tag19 | Risky person | 64 | Same format as above |

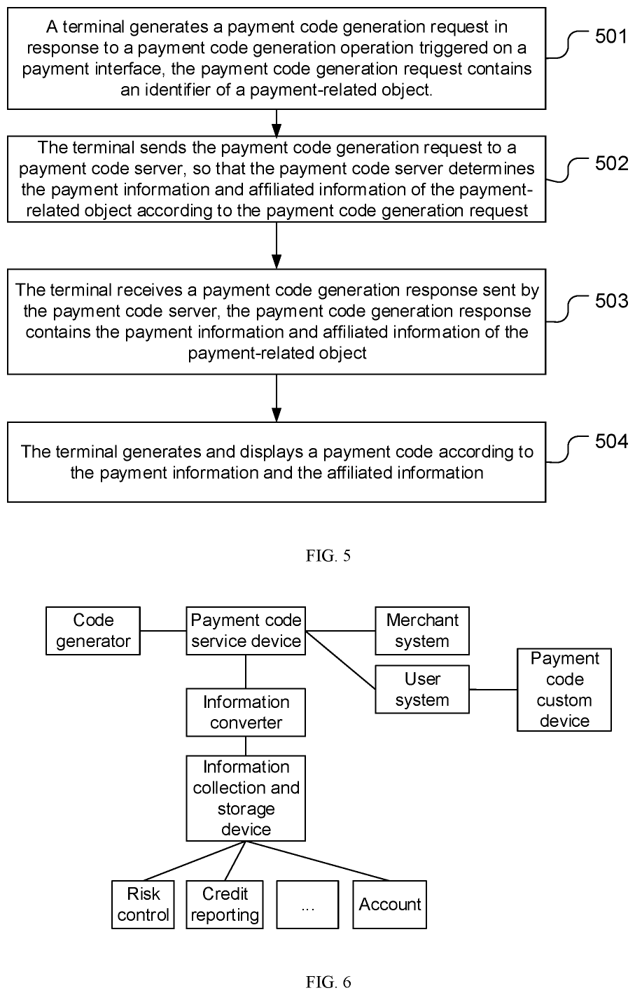

Referring to the system architecture shown in FIG. 6, the interaction process between the terminal and the server in the above embodiments will be further illustrated below in detail by using a specific application scenario, wherein a code generator is arranged in the terminal, and the payment code server includes a payment code service device, an information converter, and an information collection and storage device. The process is as follows.

The code generator initiates a code generation request to the payment code service device according to a user ID.

The payment code service device requests the account information of the user ID from the user system, and the user system returns a default or specified payment account number or card number of the user ID as well as the custom parameters of the generated code pre-defined by the user.

The payment code service device requests the affiliated information required by the generated code from the information converter according to the custom parameters of the generated code.

The information collection and storage device collects the information of a user-specified payment account number or card number periodically or in real time according to a request, and returns the information to the information converter.

The information converter converts and processes the collected affiliated information of the generated code according to the custom parameters of the generated code of the user to generate, for example, a reminder that the credit card is unpaid and a generated code style, a reminder whether the monthly cumulative consumption is excessive and a generated code style, etc., as well as the order numbers of priorities of these pieces of prompt information, and returns the above information to the payment code service device.

The payment code service device fills the necessary information and service information for code generation into an interface message and returns it to the code generator.

The code generator judges whether there is prompt information that meets the conditions according to the priority order of the affiliated information; if not, the code generator generates a default code; if so, the code generator generates a code according to the generated code style (such as color, shape, etc.) in the prompt information. Only the information with the highest priority may be prompted according to the user settings, or all pieces of prompt information meeting the conditions may be presented in sequence at a fixed time interval.

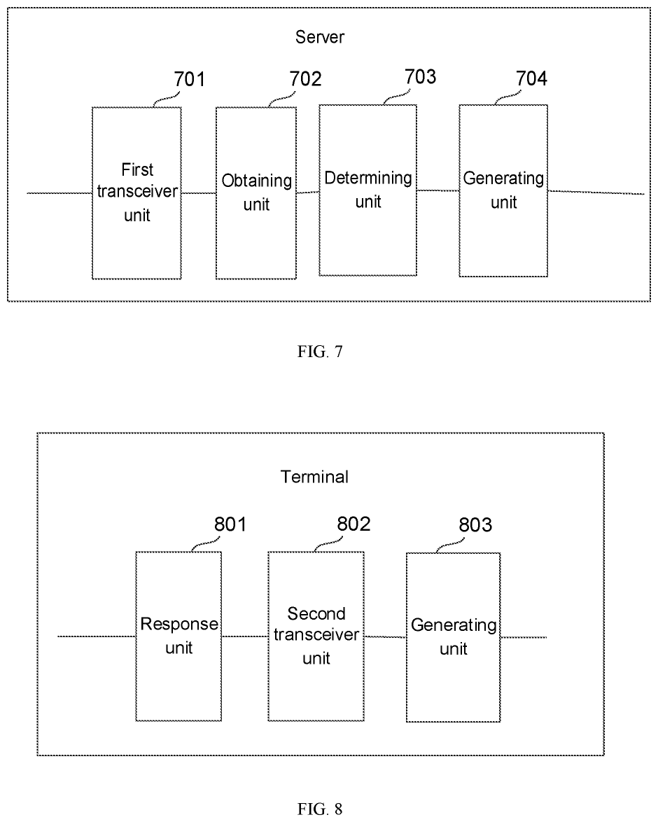

Based on the same inventive concept, referring to FIG. 7, embodiments of the invention provide a device (e.g., a server) for generating a payment code, at least including:

a first transceiver unit 701, configured to receive a payment code generation request sent by a terminal, wherein the payment code generation request contains an identifier of a payment-related object;

an obtaining unit 702, configured to obtain payment information of the payment-related object and an affiliated feature identifier of the payment-related object according to the identifier of the payment-related object;

a determining unit 703, configured to determine affiliated information of the payment-related object according to the affiliated feature identifier of the payment-related object;

a generating unit 704, configured to generate a payment code generation response according to the payment information and the affiliated information of the payment-related object;

the first transceiver unit 701 being further configured to send the payment code generation response to the terminal, so that the terminal generates a payment code according to the payment code generation response.

Optionally, the identifier of the payment-related object is a merchant identifier, and the affiliated feature identifier of the payment-related object includes at least a system preset feature identifier;

the obtaining unit is configured to:

send a first payment code information obtaining request to a merchant management server according to the merchant identifier;

receive a first payment code information obtaining response sent by the merchant management server, wherein the first payment code information obtaining response contains payment information corresponding to the merchant identifier;

determine a corresponding system preset feature identifier according to the merchant identifier.

Optionally, the identifier of the payment-related object is a user identifier, and the affiliated feature identifier of the payment-related object includes a system preset feature identifier and a custom feature identifier;

the obtaining unit is configured to:

send a second payment code information obtaining request to a user management server according to the user identifier;

receive a second payment code information obtaining response sent by the user management server, wherein the second payment code information obtaining response contains payment information and a custom feature identifier corresponding to the user identifier, and the custom feature identifier corresponding to the user identifier is determined according to a user's operation on a configuration interface of the terminal;

determine a corresponding system preset feature identifier according to the user identifier.

Optionally, the determining unit is configured to:

receive affiliated feature information of the payment-related object sent by an information management server corresponding to the payment-related object;

store the affiliated feature information and convert the affiliated feature information into the affiliated information.

Optionally, the determining unit is configured to:

generate a feature information obtaining request according to the affiliated feature identifier of the payment-related object;

send the feature information obtaining request to the information management server;

receive a feature information obtaining response sent by the information management server, wherein the feature information obtaining response includes the affiliated feature information of the payment-related object.

Optionally, the determining unit is configured to:

determine a corresponding information affiliation rule according to the affiliated feature identifier of the payment-related object;

compare the affiliated feature information with the information affiliation rule to obtain the affiliated information.

Based on the same inventive concept, referring to FIG. 8, embodiments of the invention provide a device (e.g., a terminal) for generating a payment code, at least including:

a response unit 801, configured to generate a payment code generation request in response to a payment code generation operation triggered on a payment interface, wherein the payment code generation request contains an identifier of a payment-related object;

a second transceiver unit 802, configured to send the payment code generation request to a payment code server, so that the payment code server determines payment information and affiliated information of the payment-related object according to the payment code generation request;

the second transceiver unit 802 being further configured to receive a payment code generation response sent by the payment code server, wherein the payment code generation response contains the payment information and affiliated information of the payment-related object;

a generating unit 803, configured to generate and display a payment code according to the payment information and the affiliated information.

Optionally, the identifier of the payment-related object is a user identifier; and the affiliated information is determined by the payment code server according to a system preset feature identifier and a custom feature identifier;

the response unit 801 is configured to display a configuration interface corresponding to the user identifier; and obtain a custom feature identifier corresponding to the user identifier in response to a user operation triggered on the configuration interface;

the second transceiver unit 802 is further configured to send the custom feature identifier corresponding to the user identifier to a user management server, so that the payment code server obtains the custom feature identifier from the user management server.

Optionally, the generating unit 803 is configured to:

determine target affiliated information according to a priority corresponding to the affiliated information;

determine a target generated code style corresponding to the target affiliated information according to a correspondence between affiliated information and payment code style;

generate a payment code according to the payment information, and display the payment code according to the target generated code style.

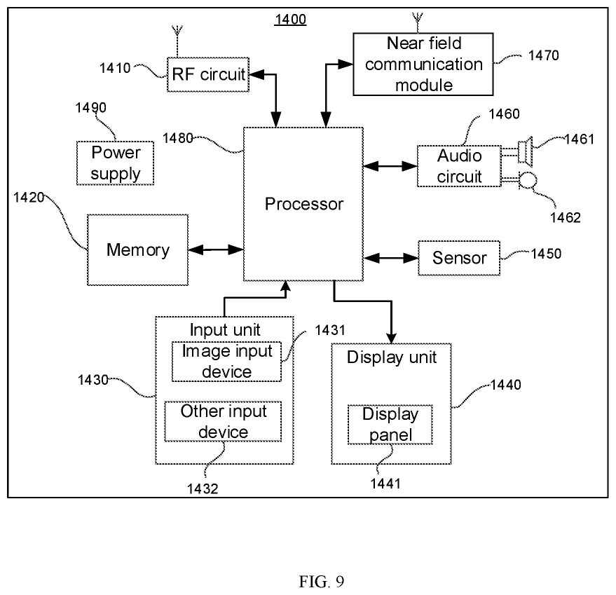

Based on the same inventive concept, referring to FIG. 9, embodiments of the invention further provide a computer device 1400, which may be an electronic device such as a smart phone, a tablet computer, a laptop computer or a PC. As shown in FIG. 9, the computer device 1400 includes a display unit 1440, a processor 1480 and a memory 1420. The display unit 1440 includes a display panel 1441, configured to display information input by a user or information provided to the user and various object selection pages of the computer device 1400, etc., and mainly configured to display pages, shortcut windows and the like of applications installed in the computer device 1400 in the embodiments of the invention. Optionally, the display panel 1441 may be configured in the form of Liquid Crystal Display (LCD) or Organic Light-Emitting Diode (OLED) or the like. The computer device 1400 can execute any one of the methods executed by the terminal or the processing server in the above-mentioned various embodiments.

The processor 1480 is configured to read a computer program, and then execute the method defined by the computer program. For example, the processor 1480 reads a social application program, so as to run the application on the computer device 1400 and display the page of the application on the display unit 1440. The processor 1480 may include one or more general-purpose processors, and may further include one or more Digital Signal Processors (DSPs), which are configured to perform the related operations to implement the technical solutions provided by the embodiments of the invention.

The memory 1420 generally includes an internal memory and an external memory, and the internal memory may be Random Access Memory (RAM), Read Only Memory (ROM), cache (CACHE), etc. The external memory may be a hard disk, an optical disk, a USB disk, a floppy disk, a tape drive, etc. The memory 1420 is configured to store computer programs and other data, the computer programs include application programs corresponding to applications, etc., and the other data may include data generated after an operating system or an application program is run, where the data includes system data (such as configuration parameters of the operating system) and user data. In an embodiment of the invention, the program instructions are stored in the memory 1420, and the processor 1480 executes the program instructions stored in the memory 1420 to implement any method performed by the terminal or processing server discussed above.

Moreover, the computer device 1400 may further include a display unit 1440, configured to receive the input numerical information, character information or a contact touch operation/non-contact gesture, and generate a signal input related to the user settings and function control of the computer device 1400, etc. Specifically, in an embodiment of the invention, the display unit 1440 may include a display panel 1441. The display panel 1441 is, for example, a touch screen, which can collect the user's touch operations on or near it (such as the player's operations on the display panel 1441 or near the display panel 1441 by using a finger, a stylus, or any suitable object or accessory), and drive a corresponding connection device according to a preset program. Optionally, the display panel 1441 may include two parts: a touch detection device and a touch controller, wherein the touch detection device detects the touch orientation of the user, detects the signal generated from the touch operation, and transmits the signal to the touch controller; and the touch controller receives the touch information from the touch detection device, converts it into the contact coordinates and then sends them to the processor 1480, and can receive and execute the commands sent by the processor 1480.

Here, the display panel 1441 may be implemented in various types, such as resistance type, capacitive type, infrared, surface acoustic wave, etc. In addition to the display unit 1440, the computer device 1400 may also include an input unit 1430, which may include, but not limited to, one or more of physical keyboard, function key (such as volume control key, switch key, etc.), trackball, mouse, joystick, etc. In FIG. 9, the input unit 1430 includes an image input device 1431 and other input device 1432 as an example.

In addition, the computer device 1400 may also include a power supply 1490 for powering other modules, an audio circuit 1460, a near field communication module 1470, and an RF circuit 1410. The computer device 1400 may also include one or more sensors 1450, such as acceleration sensor, light sensor, pressure sensor, etc. The audio circuit 1460 specifically includes a speaker 1461 and a microphone 1462, etc. For example, the user can use voice control, and the computer device 1400 can collect the user's voice through the microphone 1462, control the user's voice, and play the corresponding prompt tone through the speaker 1461 when the user needs to be prompted.

Based on the same inventive concept, embodiments of the invention provide a computer readable medium, where instructions in the computer readable storage medium, when executed by a processor, enable the processor to perform any method performed by the terminal or processing server in the foregoing embodiments.

Optionally, the computer readable medium may be a non-transitory computer-readable storage medium. For example, the non-transitory computer-readable storage medium may be ROM, Random Access Memory (RAM), CD-ROM, magnetic tape, floppy disk, optical data storage device, etc.

Based on the same inventive concept, embodiments of the invention provide a computer program product or a computer program, including computer instructions, which are stored in a computer readable storage medium. The processor of the computer device reads the computer instructions from the computer readable storage medium, and the processor executes the computer instructions, so that the computer device performs any method performed by the terminal and processing server in the foregoing embodiments.

The program product may use any combination of one or more readable media. The readable medium may be a readable signal medium or a readable storage medium. The readable signal medium may be, for example but not limited to, electrical, magnetic, optical, electromagnetic, infrared, or semiconductor system, apparatus or device, or any combination thereof. More specific examples of the readable storage media (non-exhaustive list) include: electrical connection with one or more wires, portable disk, hard disk, Random Access Memory (RAM), Read Only Memory (ROM), Erasable Programmable Read Only Memory (EPROM) or flash memory, optical fiber, portable Compact Disk-Read Only Memory (CD-ROM), optical storage device, magnetic storage device, or any suitable combination thereof.

The program product of the embodiment of the invention may adopt a portable Compact Disk-Read Only Memory (CD-ROM) and include program codes, and may be run on a computing device. However, the program product of the invention is not limited to this. In this document, the readable storage medium can be any tangible medium that contains or stores a program, where the program can be used by or used in combination with a command execution system, apparatus or device.

The readable signal medium may include data signals propagated in the baseband or as a part of carrier waves, and the readable program codes are beared therein. Such propagated data signals can be in many forms, including but not limited to electromagnetic signals, optical signals, or any suitable combination thereof. The readable signal medium may also be any readable medium other than the readable storage medium, and the readable medium may send, propagate or transmit the programs used by or used in combination with a command execution system, apparatus or device.

The program codes contained on the readable medium can be transmitted by any suitable medium, including but not limited to wireless, wired, optical cable, RF, etc., or any suitable combination thereof.

Based on the same inventive concept, an embodiment of the invention provides a computer program product, including a computer program stored on a computer readable storage medium, where the computer program includes program instructions which, when executed by a computer, cause the computer to perform the steps of the payment code generation method described above.

Although the preferred embodiments of the invention have been described, those skilled in the art can make additional alterations and modifications to these embodiments once they learn about the basic creative concepts. Thus the attached claims are intended to be interpreted to include the preferred embodiments as well as all the alterations and modifications falling within the scope of the invention.

Evidently those skilled in the art can make various modifications and variations to the invention without departing from the spirit and scope of the invention. Thus the invention is also intended to encompass these modifications and variations therein as long as these modifications and variations come into the scope of the claims of the invention and their equivalents.

1. A method for generating a payment code, comprising:
receiving a payment code generation request sent by a terminal, wherein the payment code generation request comprises an identifier of a payment-related object;
obtaining payment information of the payment-related object and an affiliated feature identifier of the payment-related object according to the identifier of the payment-related object;
determining affiliated information of the payment-related object according to the affiliated feature identifier of the payment-related object;
generating a payment code generation response according to the payment information and the affiliated information of the payment-related object, and sending the payment code generation response to the terminal, so that the terminal generates the payment code according to the payment code generation response;
wherein the identifier of the payment-related object is a merchant identifier, and the affiliated feature identifier of the payment-related object comprises at least a system preset feature identifier;
said obtaining payment information of the payment-related object and an affiliated feature identifier of the payment-related object according to the identifier of the payment-related object, comprises:
sending a first payment code information obtaining request to a merchant management server according to the merchant identifier;
receiving a first payment code information obtaining response sent by the merchant management server, wherein the first payment code information obtaining response comprises payment information of the merchant identifier;
determining a corresponding system preset feature identifier according to the merchant identifier.

2. (canceled)

3. A method for generating a payment code, comprising:
receiving a payment code generation request sent by a terminal, wherein the payment code generation request comprises an identifier of a payment-related object,
obtaining payment information of the payment-related object and an affiliated feature identifier of the payment-related object according to the identifier of the payment-related object;
determining affiliated information of the payment-related object according to the affiliated feature identifier of the payment-related object;
generating a payment code generation response according to the payment information and the affiliated information of the payment-related object, and sending the payment code generation response to the terminal, so that the terminal generates the payment code according to the payment code generation response;
wherein the identifier of the payment-related object is a user identifier, and the affiliated feature identifier of the payment-related object comprises a system preset feature identifier and a custom feature identifier;
said obtaining payment information of the payment-related object and an affiliated feature identifier of the payment-related object according to the identifier of the payment-related object, comprises:
sending a second payment code information obtaining request to a user management server according to the user identifier;
receiving a second payment code information obtaining response sent by the user management server, wherein the second payment code information obtaining response comprises payment information of the user identifier and a custom feature identifier corresponding to the user identifier, and the custom feature identifier corresponding to the user identifier is determined according to a user's operation on a configuration interface of the terminal;
determining a corresponding system preset feature identifier according to the user identifier.

4. The method of claim 1, wherein said determining affiliated information of the payment-related object according to the affiliated feature identifier of the payment-related object, comprises:
receiving affiliated feature information of the payment-related object sent by an information management server corresponding to the payment-related object;
storing the affiliated feature information and converting the affiliated feature information into the affiliated information.

5. The method of claim 4, wherein before receiving the affiliated feature information of the payment-related object sent by the information management server corresponding to the payment-related object, the method further comprises:
generating a feature information obtaining request according to the affiliated feature identifier of the payment-related object;
sending the feature information obtaining request to the information management server;
said receiving affiliated feature information of the payment-related object sent by the information management server corresponding to the payment-related object, comprises:
receiving a feature information obtaining response sent by the information management server, wherein the feature information obtaining response comprises the affiliated feature information of the payment-related object.

6. The method of claim 4, wherein said converting the affiliated feature information into the affiliated information, comprises:
determining a corresponding information affiliation rule according to the affiliated feature identifier of the payment-related object;
comparing the affiliated feature information with the information affiliation rule to obtain the affiliated information.

7. A method for generating a payment code, comprising:
generating a payment code generation request in response to a payment code generation operation triggered on a payment interface, wherein the payment code generation request comprises an identifier of a payment-related object;
sending the payment code generation request to a payment code server, so that the payment code server determines payment information and affiliated information of the payment-related object according to the payment code generation request;
receiving a payment code generation response sent by the payment code server, wherein the payment code generation response comprises the payment information and affiliated information of the payment-related object;
generating and displaying the payment code according to the payment information and the affiliated information;
wherein the identifier of the payment-related object is a user identifier; and the affiliated information is determined by the payment code server according to a system preset feature identifier and a custom feature identifier;
before generating the payment code generation request in response to the payment code generation operation triggered on the payment interface, wherein the payment code generation request comprises the identifier of the payment-related object, the method further comprises:
displaying a configuration interface corresponding to the user identifier;
obtaining the custom feature identifier corresponding to the user identifier in response to a user operation triggered on the configuration interface;
sending the custom feature identifier corresponding to the user identifier to a user management server, so that the payment code server obtains the custom feature identifier from the user management server.

8. (canceled)

9. The method of claim 7, wherein said generating the payment code according to the payment information and the affiliated information, comprises:
determining target affiliated information according to a priority corresponding to the affiliated information;
determining a target generated code style corresponding to the target affiliated information according to a correspondence between affiliated information and payment code style;
generating the payment code according to the payment information, and displaying the payment code according to the target generated code style.

10. (canceled)

11. (canceled)

12. An electronic device, comprising:
a memory, configured to store executable instructions;
a processor, configured to read and execute the executable instructions stored in the memory to implement the method according to claim 1.

13. A computer readable storage medium, wherein instructions in the computer readable storage medium, when executed by a processor, enable the processor to perform the method according to claim 1.

14. (canceled)

15. The method of claim 3, wherein said determining affiliated information of the payment-related object according to the affiliated feature identifier of the payment-related object, comprises:
receiving affiliated feature information of the payment-related object sent by an information management server corresponding to the payment-related object;
storing the affiliated feature information and converting the affiliated feature information into the affiliated information.

16. The method of claim 15, wherein before receiving the affiliated feature information of the payment-related object sent by the information management server corresponding to the payment-related object, the method further comprises:
generating a feature information obtaining request according to the affiliated feature identifier of the payment-related object;
sending the feature information obtaining request to the information management server;
said receiving affiliated feature information of the payment-related object sent by the information management server corresponding to the payment-related object, comprises:
receiving a feature information obtaining response sent by the information management server, wherein the feature information obtaining response comprises the affiliated feature information of the payment-related object.

17. The method of claim 15, wherein said converting the affiliated feature information into the affiliated information, comprises:
determining a corresponding information affiliation rule according to the affiliated feature identifier of the payment-related object;
comparing the affiliated feature information with the information affiliation rule to obtain the affiliated information.

18. An electronic device, comprising:
a memory, configured to store executable instructions;
a processor, configured to read and execute the executable instructions stored in the memory to implement the method according to claim 3.

19. A computer readable storage medium, wherein instructions in the computer readable storage medium, when executed by a processor, enable the processor to perform the method according to claim 3.
